(19) United States
(12) Patent Application Publication
(10) Pub. No.: US 2023/0202828 A1
(43) Pub. Date: Jun. 29, 2023

(54) ENVIRONMENTALLY FRIENDLY MULTIFUEL FUELING PLATFORM

(71) Applicant: CAPAT LLC, MIAMI, FL (US)

(72) Inventors: JOSE A. CAJIGA, MIAMI, FL (US); ARTURO CAJIGA VILLAR, MIAMI, FL (US); VICENTE CAJIGA VILLAR, MIAMI, FL (US); ALEXANDRA CAJIGA, MIAMI, FL (US)

(73) Assignee: CAPAT LLC, MIAMI, FL (US)

(21) Appl. No.: 18/086,149

(22) Filed: Dec. 21, 2022

Related U.S. Application Data
(60) Provisional application No. 63/292,017, filed on Dec. 21, 2021.

(51) Int. Cl. B67D 7/84; B67D 7/78; F17C 7/02; B60L 53/30; B60L 53/53

(52) U.S. Cl. CPC B67D 7/84; B67D 7/78; F17C 7/02; B60L 53/30; B60L 53/53; F17C 2270/0139; F17C 2221/033; F17C 2221/035; F17C 2221/012; F17C 2205/013; F17C 2205/0103; F17C 2265/065

(57) ABSTRACT

An environmentally friendly multifuel fueling platform includes a tower structure and a canopy structure supported on legs a predetermined distance above ground to facilitate the passage of land vehicles beneath. The canopy structure is releasably affixed to the tower structure. An energy source is housed within the canopy structure and the tower provides access to the canopy from the ground, as well as providing operational supply of one of a liquid, gaseous and electrical energies to the energy source.

### CROSS-REFERENCE TO RELATED APPLICATIONS

This application claims the benefit of U.S. Provisional Application Ser. No. 63/292,017, filed on Dec. 21, 2021, which is hereby incorporated by reference in its entirety.

### FIELD OF THE INVENTION

The present invention relates generally to a fuel distribution station, and more particularly, to an environmentally friendly, multifuel fueling platform that is modular in nature and is capable of dispensing multiple fuels while providing for future expansion or contraction of the platform itself.

### BACKGROUND

Fueling stations for dispensing gas-based fuels are widely known. Most of these stations dispense only a single type of fuel, and require extensive site development in order to prepare for the underground storage of gas tanks and the like, even before construction of the station itself can begin.

The necessity of burying fueling tanks underground, however, is fraught with potential dangers and liabilities, as such tanks tend to corrode over time, leak their stored fuel into surrounding ground water and generally inhibit future use of the site by requiring costly reclamation and removal of the buried fuel tanks, as well as raising other environmentally sensitive considerations.

Still further, the installation of known fueling stations is oftentimes impeded or even prohibited by local/national regulations that prohibit the construction of known fueling stations in areas of high-water tables, those areas prone to flooding and/or where the ground is resistant to excavation.

Known fueling stations also suffer due to their inability to easily expand or reduce their overall structural footprint, as desired and/or required, over time.

### SUMMARY OF THE INVENTION

The present invention seeks to overcome the deficiencies of known, single-fuel fueling stations by proposing an environmentally friendly multifuel fueling platform.

It is therefore an important aspect of the present invention to provide a fueling platform that is modular in nature, to thereby provide for efficient expansion or reduction in the structural footprint of the fueling platform.

It is another aspect of the present invention to provide a fueling platform that occupies much less space—i.e., has a much smaller footprint—than known fueling stations. For example, with the case of hydrogen. The hydrogen tanks and equipment take up a lot of (surface) space, and by supporting these items on the present invention's canopy (as will be described later), that extra space is not needed.

A similar consideration exists with, e.g., CNG equipment and CNG tanks, as well as for EV fast charging.

It is another aspect of the present invention to provide a fueling platform from which hydrogen-based fuel may be dispensed.

It is another aspect of the present invention to provide a fueling platform that utilizes a tower and canopy design within which to hold the platform's operational components and fuel tanks (or other fuel/energy equipment, such as Hs, CNG, etc.), thereby avoiding the need for any earthen excavation or surface ground space to house the same.

It is another aspect of the present invention to provide a fueling platform with a modular tank system in which a single pumping station can access one or more interconnected fuel tanks, thereby avoiding the need for excessively large fuel tanks, while also reducing operational costs and simplifying maintenance of the same.

It is another object of the present invention to provide a fuel distribution station that has storage tanks capable of storing various types of fuel such as gasoline, diesel, CNG (compressed natural gas), LPG (liquefied petroleum gas), LNG, hydrogen (H2, LH2) and ethanol.

It is another object of the present invention to provide a fuel distribution station that can supply various types of fuel such as gasoline, diesel, biodiesel, hydrogen, ethanol, CNG, LPG and electric power.

It is another object of the present invention to provide a fuel distribution station having container assemblies that can easily be exchanged with other assemblies to replace equipment contained by such assemblies, and to perform maintenance on equipment without having long periods of down time.

These and other objects of the present invention, and their preferred embodiments, shall become clear by consideration of the specification, claims and drawings taken as a whole.

### BRIEF DESCRIPTION OF DRAWINGS

The present invention will be better understood from reading the following description of non-limiting embodiments, with reference to the attached drawings, wherein below:

FIG. 1 is an isomeric view of an environmentally friendly multifuel fueling platform, in accordance with one embodiment of the present invention.

FIG. 2 is an isometric view of the environmentally friendly multifuel fueling platform shown in FIG. 1.

FIG. 3 is an exploded view of the environmentally friendly multifuel fueling platform shown in FIG. 1.

FIG. 4 illustrates the modular nature of the fuel tanks utilized with the environmentally friendly multifuel fueling platform shown in FIG. 1, in accordance with one embodiment of the present invention.

FIG. 5A illustrates a configuration, having 4 fueling positions, that is possible with the modular environmentally friendly multifuel fueling platform of the present invention.

FIG. 5B illustrates another configuration, having 6 fueling positions, that is possible with the modular environmentally friendly multifuel fueling platform of the present invention.

FIG. 5C illustrates another configuration, having 8 fueling positions, that is possible with the modular environmentally friendly multifuel fueling platform of the present invention.

FIG. 5D illustrates another configuration, having 10 fueling positions, that is possible with the modular environmentally friendly multifuel fueling platform of the present invention.

FIG. 5E illustrates another configuration, having 14 fueling positions, that is possible with the modular environmentally friendly multifuel fueling platform of the present invention.

FIG. 6 illustrates an alternative embodiment of the modular environmentally friendly multifuel fueling platform 100 of the present invention, in which suspended fuel dispensers are utilized.

FIG. 7A is a partial cutaway, top plan view of an environmentally friendly multifuel fueling platform, in accordance with another embodiment of the present invention.

FIG. 7B is a top plan view of the environmentally friendly multifuel fueling platform of FIG. 7A.

FIG. 7C is a side elevational view of the environmentally friendly multifuel fueling platform of FIG. 7A.

FIG. 7D is a front elevational view of the environmentally friendly multifuel fueling platform of FIG. 7A.

FIG. 8A is a partial cutaway, top plan view of an environmentally friendly multifuel fueling platform, in accordance with another embodiment of the present invention.

FIG. 8B is a top plan view of the environmentally friendly multifuel fueling platform of FIG. 8A.

FIG. 8C is a side elevational view of the environmentally friendly multifuel fueling platform of FIG. 8A.

FIG. 8D is a front elevational view of the environmentally friendly multifuel fueling platform of FIG. 8A.

FIG. 9A is a partial cutaway, top plan view of an environmentally friendly multifuel fueling platform, in accordance with another embodiment of the present invention.

FIG. 9B is a top plan view of the environmentally friendly multifuel fueling platform of FIG. 9A.

FIG. 9C is a side elevational view of the environmentally friendly multifuel fueling platform of FIG. 9A.

FIG. 9D is a front elevational view of the environmentally friendly multifuel fueling platform of FIG. 9A.

### DETAILED DESCRIPTION OF THE PREFERRED EMBODIMENT

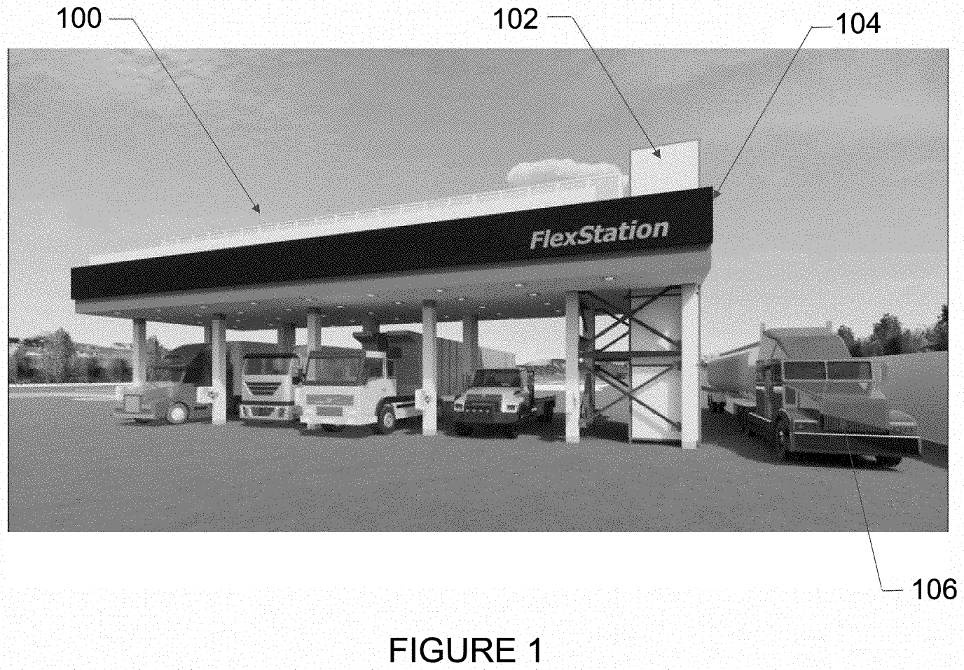

Referring to FIG. 1, an environmentally friendly multifuel fueling platform 100 is shown, in accordance with one embodiment of the present invention. The environmentally friendly multifuel fueling platform 100 includes a tower 102 and canopy 104 construction that is designed to be modular for ease of expansion or reduction, as will be discussed in more detail later. The canopy 104 is designed to support one or more fuel tanks (and/or, as will be described in more detail later, fueling equipment for, e.g., H2, CNG, EV charging) therein, along with most of the accompanying structures, pumps and safety equipment of the fueling platform 100. The tower 102 is itself constructed to achieve a multitude of objectives, including providing a means of egress to reach the canopy 104 for maintenance and/or expansion, as well as housing all the needed conduits, valves and control systems for dispensing a fuel from a refueling vehicle 106 (or, other sources of energy (ex: grid for electric charge), up through the tower 102 and into one or more fuel tanks housed within the canopy 104.

It will therefore be readily appreciated that the tower 102 and canopy 104 design of the present invention eliminates the need for any earthen excavation to house the fuel tanks and control structures/equipment underground, or to utilize surface space for the same, as is commonly known, and as such, removes the possibility of ground contamination over time, while reducing overall ground/space usage.

Moreover, by housing all fuel tanks and most operational equipment within the canopy 104, the present invention is able to be constructed even in flood prone areas, or where excavation of the ground is impossible or prohibitively expensive. As will also be appreciated, by housing the pumping equipment and various conduits in a single location, the tower 102 provides for ease of maintenance and communication with various fueling vehicles 106.

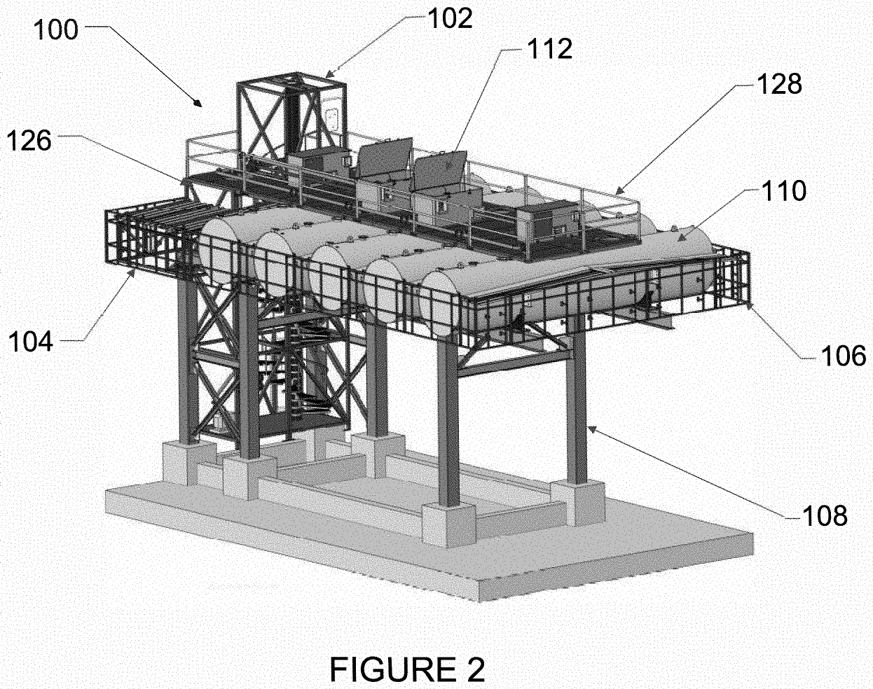

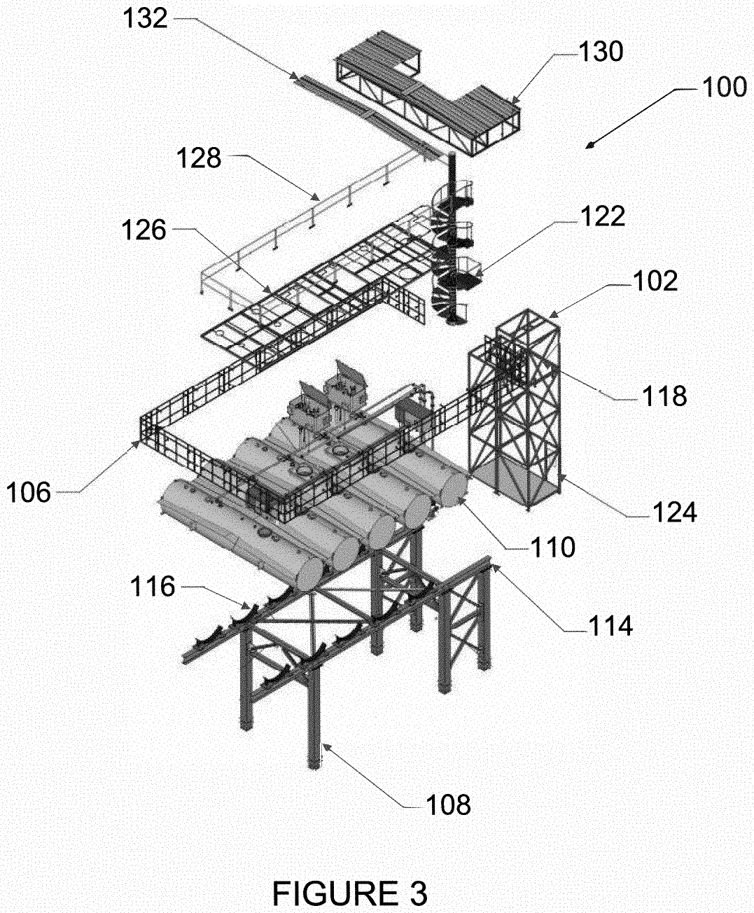

FIGS. 2 and 3 illustrate both an isometric view of the environmentally friendly multifuel fueling platform 100, and an exploded view, respectively, according to one embodiment of the present invention. As shown in FIG. 2, the canopy 104 defines a metal support structure 106 held in an elevated position a predetermined distance above the ground via one or more support legs 108. It will be readily appreciated that the support legs 108 may be of any particular dimension/height, in dependence upon the operating requirements of the environmentally friendly multifuel fueling platform 100.

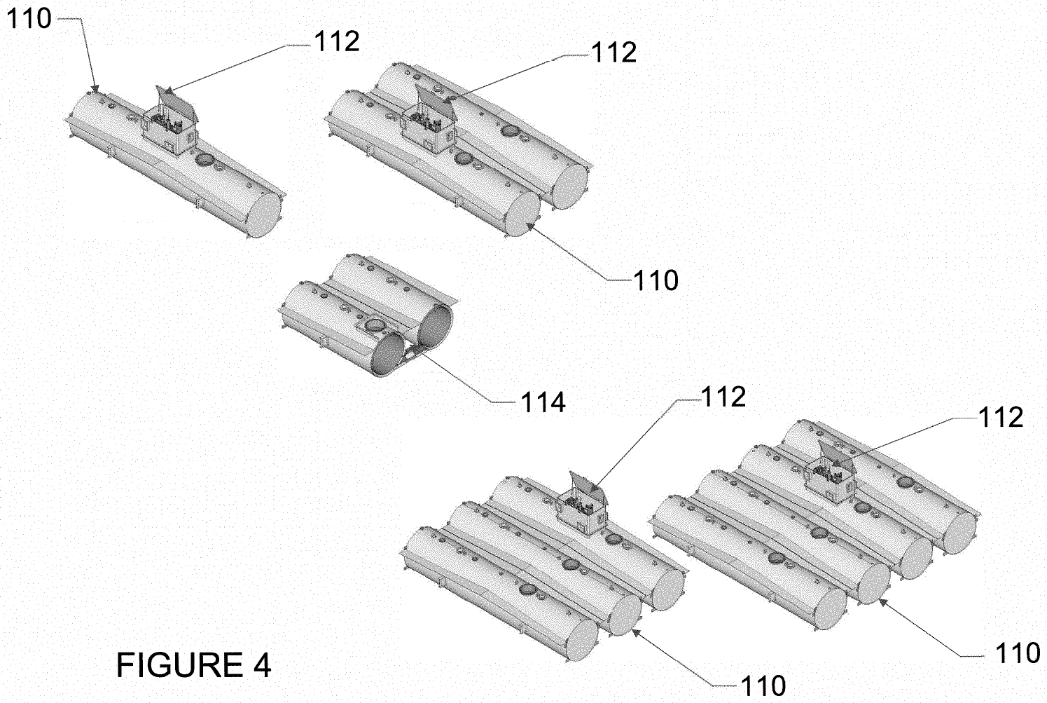

As also shown in FIG. 2, a plurality of liquid fuel tanks 110 are securely housed within the metal support structure 106. It is an important aspect of the present invention that the fuel tanks 110 are designed to be modular in nature, and capable of being operatively interconnected so as to provide for an effective storage of fuel in a quantity far above the capacity of any single fuel tank 110. Indeed, as shown in FIG. 4, a ballistic and puncture resistant fuel tank 110 can be formed to hold a reasonable amount of fuel, e.g., 5000 gallons, alone, or alternatively, two or more fuel tanks can be interconnected within the metal support structure 106, as desired. As will be appreciated, by interconnecting various fuel tanks 110 to one another, a single pumping station 112 can be utilized, instead of requiring a separate pumping station 112 for each individual tank. Moreover, the effective capacity of the environmentally friendly multifuel fueling platform 100 can be increased to whatever capacity is needed, simply by adding another fuel tank 110, and without requiring the production and support of a burdensome and very heavy large-capacity (e.g., 20,000 gallon) single fuel tank. Each of the fuel tanks 110 may be selectively connected to one another to form a much larger collective fuel tank, as shown in the cross-section 114.

Turning now to FIG. 3, an exploded view of the environmentally friendly multifuel fueling platform 100 is shown. As illustrated in FIG. 3, the metal support structure 106 is supported on multiple legs 108 and a plurality of metal support beams 114. The metal support beams 114 themselves support pairs of tank bases 116 (and/or equipment) which may be easily added or removed from the support beams 114, as needed, to alter the size and capacity of the environmentally friendly multifuel fueling platform 100.

As further shown in FIG. 3, the tower 102 is formed to define a modular metal superstructure 118 that may be positioned adjacent the canopy 104 to accommodate the various filling and dispensing conduits 120 that are connected to the fuel tanks 110. The tower 102 also provides a stairway 122 by which access to the fuel tanks 110 (and/or equipment) and canopy 104 may be effectuated. Access to the tower 102 of the environmentally friendly multifuel fueling platform 100 may be provided through one or more doors 124 of the tower 102. Refueling operations may also be effected through doors 124.

As shown, the tower 102 provides access to the top side of the canopy 104 with a spiral stairs and doors to control the access to it. In accordance with one embodiment of the present invention, the tower 102, at 1st level and 2nd level are rooms/space to hold: electrical panels and/or pumps and filters (mechanical equipment) to transfer fuels from bottom to the top side where the equipment and fuel storage is located. Also, for the EV fast charge the tower can hold electrical panels, and transformers as well power packs and batteries are located on the top side of the platform.

As perhaps best seen in FIGS. 2 and 3, the tower 102 further includes a working platform 126, extending out therefrom and over the various fuel tanks 110 (and/or equipment). The working platform 126 includes a safety rail 128, and provides a walkable support surface upon which to arrange all of the needed control and fire prevention systems of the environmentally friendly multifuel fueling platform 100, including providing a support for one or more pumping stations 112 (and/or to place any other equipment related to fuel/energy storage or dispensing). A metallic or other nonflammable roof 130 is designed with roofing panels 132 to cover both the top of the tower 102, and the metal support structure 106 of the canopy 104.

The arrangement of the working platform 126 positioned above the fuel tanks 110 enables access to the fuel tanks 110 and related equipment, while permitting the removal or addition of fuel tanks 110 therefrom, as needed.

As will be appreciated by a review of FIGS. 1-4 in combination, the environmentally friendly multifuel fueling platform 100 of the present invention is capable of supporting multiple fuel tanks 110 (and/or equipment) in an elevated position, where the fuel dispensed from any of the fuel tanks may be various types of liquid fuel such as gasoline, diesel, biodiesel, ethanol and LNG, without departing from the broader aspects of the present invention.

Moreover, the modular nature of the fuel tanks 110 themselves enables the environmentally friendly multifuel fueling platform 100 to be able to support truly enormous capacities, when needed, simply by adding more pairs of tank bases 116 on the metal support beams 114, and thus adding as many fuel tanks 110 as desired. Additional support beams and support legs may be added as needed to increase the size(or area) available in which to place tanks or equipment (e.g., H2, EV charging). The fuel tanks may be fashioned from stainless steel (or similar), and are envisioned to be double-walled tanks for strength, and puncture/fire resistance.

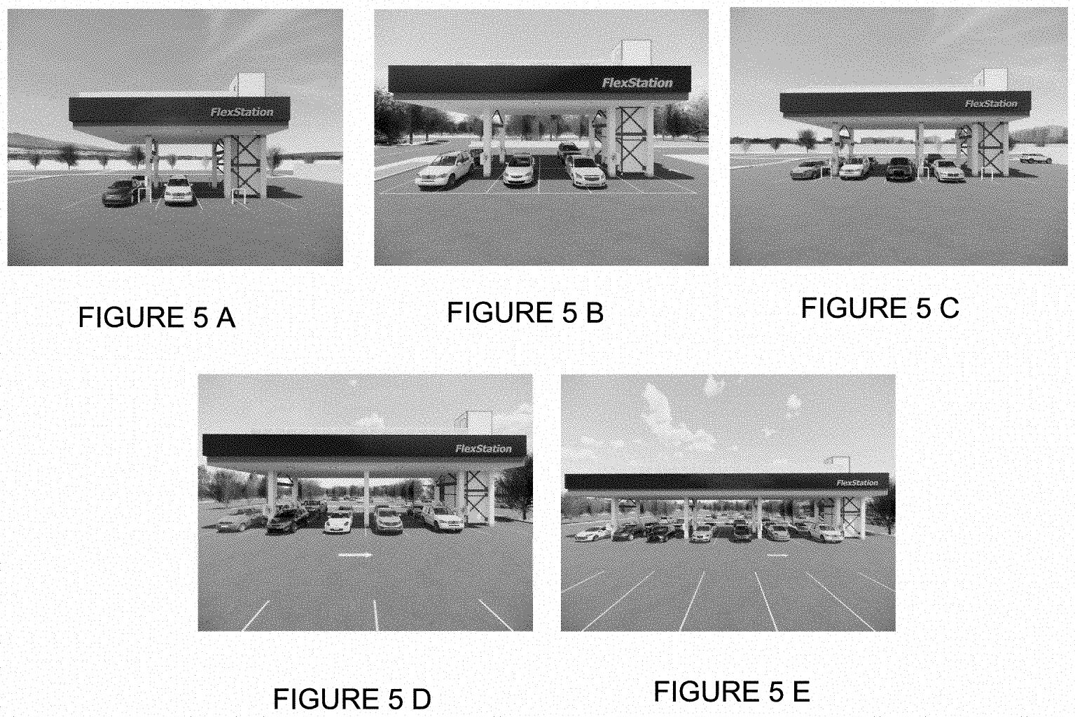

FIGS. 5A-5E illustrate only some of the various configurations that are possible with the modular environmentally friendly multifuel fueling platform 100 of the present invention. As shown in FIGS. 5A-5E, the modular nature of both the tower support structure 118 and the fuel tanks 110 (and/or the area where equipment would be located in place of the fuel tanks 110), and their associated support structures (e.g., 106/108/114/116), enables the rapid expansion or reduction of its structural footprint from a small 4 vehicle capacity, to an environmentally friendly multifuel fueling platform 100 that may have 6, 8, 10, 14 or more fueling positions.

While the embodiment shown in FIGS. 2 and 3 is primarily directed towards an environmentally friendly multifuel fueling platform 100 which is dispensing liquid fuels (e.g., gasoline, diesel, ethanol, etc.), the present invention is not so limited in this regard.

Indeed, it is a primary aspect of the present invention that the modular tower 102 and canopy 104 design of the environmentally friendly multifuel fueling platform 100 is capable of being universally utilized, regardless of whether it is dispensing a liquid fuel (such as shown with fuel tanks 110), or a gaseous fuel such as hydrogen (e.g., H2, LH2).

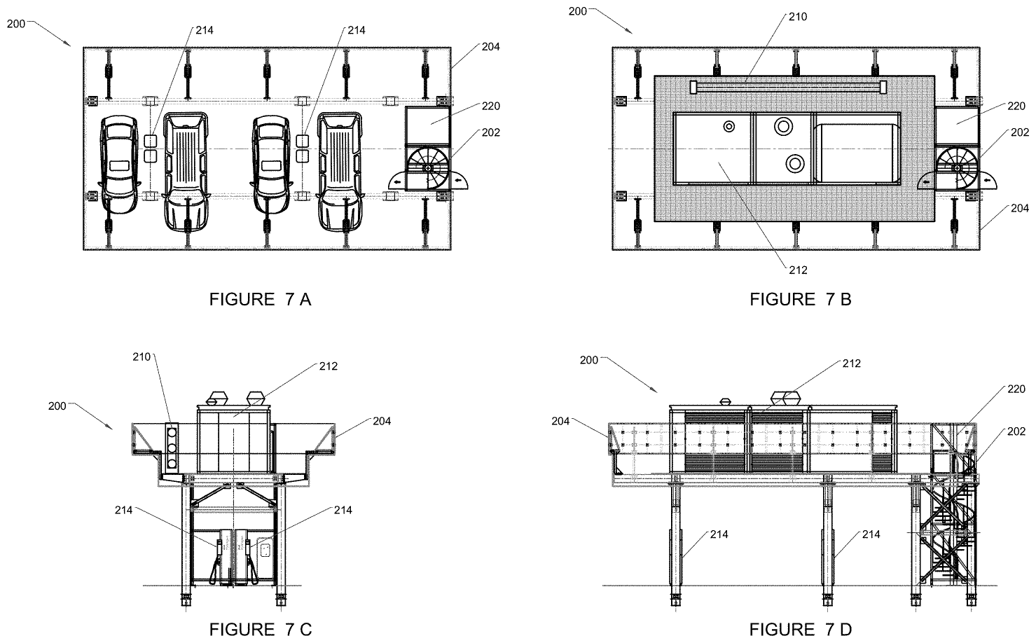

Indeed, FIGS. 7A-7D illustrate the environmentally friendly multifuel fueling platform 200 utilizing the same basic modular tower 202 and canopy 204 design as shown in FIGS. 1-6, however instead of the canopy 204 supporting a plurality of liquid fuel tanks 110, the canopy of FIGS. 7A-7D is adapted to support both high-pressure hydrogen tanks 210, as well as an associated control and dispensing equipment container 212. As shown in FIGS. 7A, 7C and 7D, the hydrogen dispensers 214 may be suspended from the canopy 204 itself, or alternatively, be located on the ground level, without departing from the broader aspects of the present invention. As shown, the modular tower 202 is three levels or blocks tall, and may include a stairwell or ladder for accessing the top of the canopy from ground level, and space 220 for housing equipment such as electrical equipment, transformers, or the like, as discussed above.

The present invention thereby provides an elevated, high-capacity gaseous hydrogen fueling platform, utilizing an advanced liquid hydrogen pump to effectively provides hydrogen fueling to vehicles passing beneath the canopy 204. High pressure receivers are employed within the canopy 204 to deliver differing pressures of, for example, 500, 700 and 850 bars, as needed to provide for differing fueling requirements.

Through the use of hydrogen dispensers that possess integrated pre-cooling of the hydrogen gas (or, having equipment to dispense gaseous fuels on the surface), the environmentally friendly multifuel fueling platform 200 of the present invention may deliver hydrogen mass flow up to 150+ kg/h/unit. The integrated hydrogen cooling system permits the system to warm the cryogenic hydrogen to ambient temperatures and to transfer the cooling energy of cryogenic fluid to a thermo-management system for pre-cooling gas at the dispenser. In this manner, the environmentally friendly multifuel fueling platform 200 of the present invention does not need additional refrigeration to effect hydrogen dispensing, which is typically an expensive addition, adds complexity to the station as a whole and consumes additional electricity to operate.

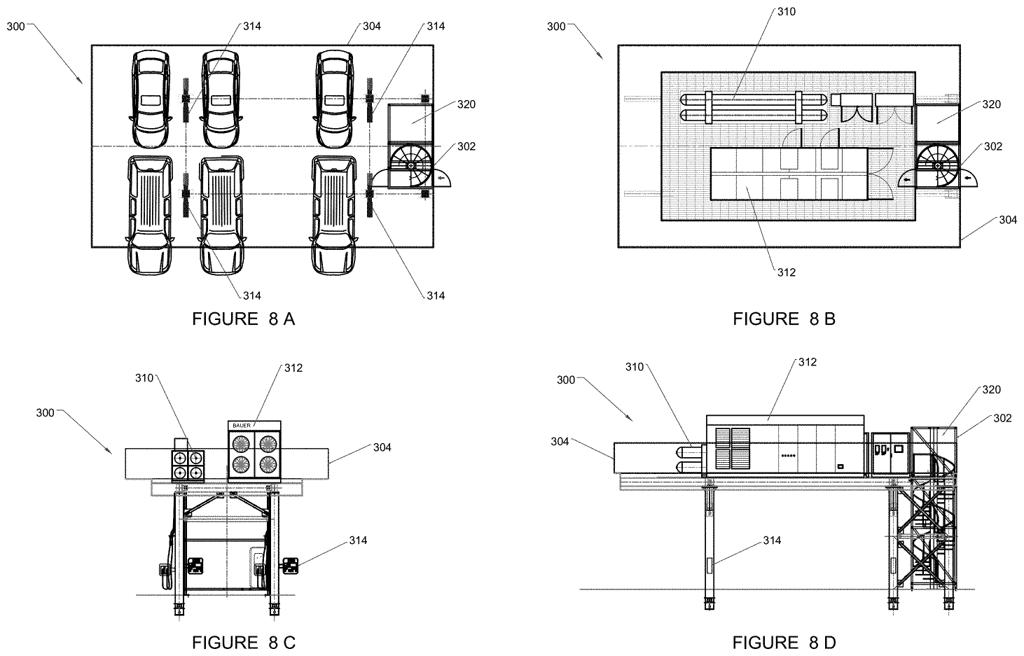

FIGS. 8A-8D illustrate yet another embodiment of the environmentally friendly multifuel fueling platform 300 utilizing the same basic modular tower 302 and canopy 304 design as shown in FIGS. 1-7D, however instead of the canopy 304 supporting a plurality of liquid fuel tanks 110 or hydrogen tanks 210, the canopy of FIGS. 8B, 8C and 8D is adapted to support both CNG (compressed natural gas) tanks 310, as well as an associated control and compressor container 312. As also shown in FIGS. 8A, 8C and 8D, the CNG dispensers 314 may be suspended from the canopy 304 itself, or alternatively, be located on the ground level, without departing from the broader aspects of the present invention. As shown, the modular tower 302 is three levels or blocks tall, and may include a stairwell or ladder for accessing the top of the canopy from ground level, and space 320 for housing equipment such as electrical equipment, transformers, or the like, as discussed above.

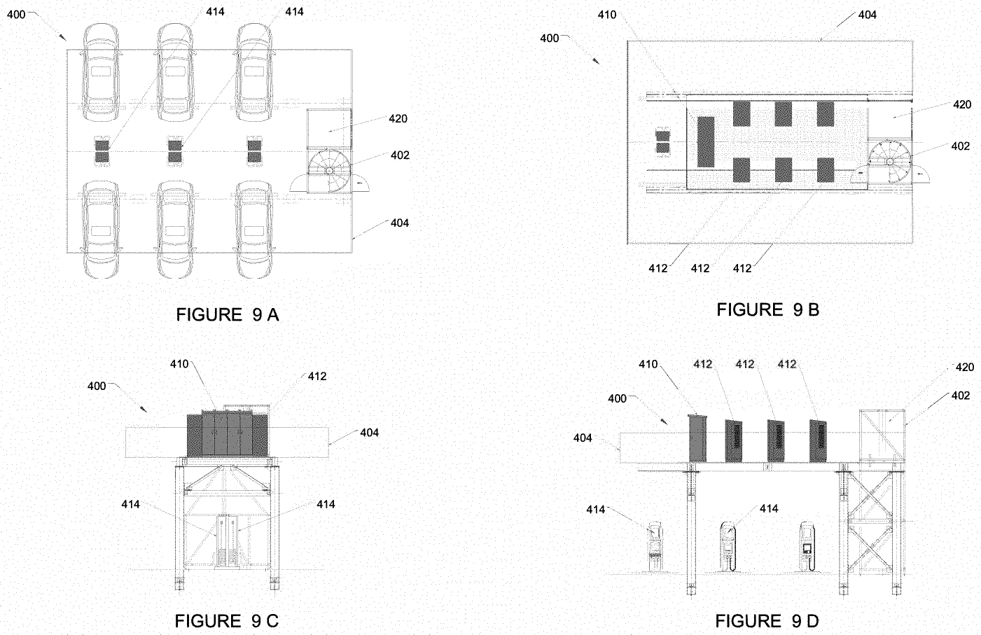

FIGS. 9A-9D another embodiment of the environmentally friendly multifuel fueling platform 400 utilizing the same basic modular tower 402 and canopy 404 design as shown in FIGS. 1-8D, however instead of the canopy 404 supporting a plurality of liquid fuel tanks 110 or hydrogen tanks 310 or CNG tanks 310, the canopy of FIG. 8 FIGS. 8B, 8C and 8D is adapted to support both an electrical distribution panel 410, as well associated electric power boxes 412. As also shown in FIGS. 9A, 9C and 9D, the electric power dispensers 414 may be suspended from the canopy 404 itself, or alternatively, be located on the ground level, without departing from the broader aspects of the present invention. As shown, the modular tower 402 is three levels or blocks tall, and may include a stairwell or ladder for accessing the top of the canopy from ground level, and space 420 for housing equipment such as electrical equipment, transformers, or the like, as discussed above.

As shown, the environmentally friendly multifuel fueling platform 400 can be used to store electricity in power packs or batteries 412, instead of, e.g., the fuel tanks 110. As is known, super-fast charging has an issue in that it works at 800 volts, and thus in regular grid connections it might unbalance the surrounding area of the grid when a vehicle charges. The batteries/electrical power boxes 412 therefore function as a buffer. In the present invention, the dispensing charge comes from the electrical power boxes 412, and then the electrical power boxes 412 are re-charged slowly from the grid or other energy sources, such as but not limited to a H2 fuel cell.

As therefore most clearly shown by a comparison of FIGS. 1-3, FIGS. 7A-7D, FIGS. 8A-8D and FIGS. 9A-9D, the modular nature of an environmentally friendly multifuel fueling platform according to the present invention is capable of utilizing a universal structure to support a plurality of possible fuels and related equipment. Thus, as compared to known fueling stations, the environmentally friendly multifuel fueling platform of the present invention is capable of first supporting and dispensing one type of fuel (e.g., liquid fuel from fuel tanks 110), and then, when desired, these tanks may be removed to be replaced by one or more of the hydrogen tanks 210 and equipment 212 of FIGS. 7A-7D, the CNG tanks 310 and equipment 312 of FIGS. 8A-8D, and/or the electrical distribution panel 410 and its own related equipment 412.

It is important to note that all of these fuel modules (i.e., the various liquid/gaseous/electrical tanks and equipment of FIGS. 1-9D) are envisioned as being stand-alone modular components, themselves, contained within their own frame or superstructure, and which may be easily mounted atop the canopy 104/204/304/404 without requiring significant structural changes to the canopy and tower itself. In this manner, the present invention provides an environmentally friendly multifuel fueling platform that may be expanded as needed, and which can be easily adapted to a plurality of fuels.

It is another important aspect of the present invention that not only is the environmentally friendly multifuel fueling platform 100 modular in nature, thus providing for ease of expansion and site placement, but that it may be easily adapted to existing fueling stations that may themselves utilize the known storage of fuel tanks underground or the like. That is, the environmentally friendly multifuel fueling platform 100 of the present invention may be easily attached to even existing fuel stations, without requiring earthen excavation and without interfering with the operations of the existing station.

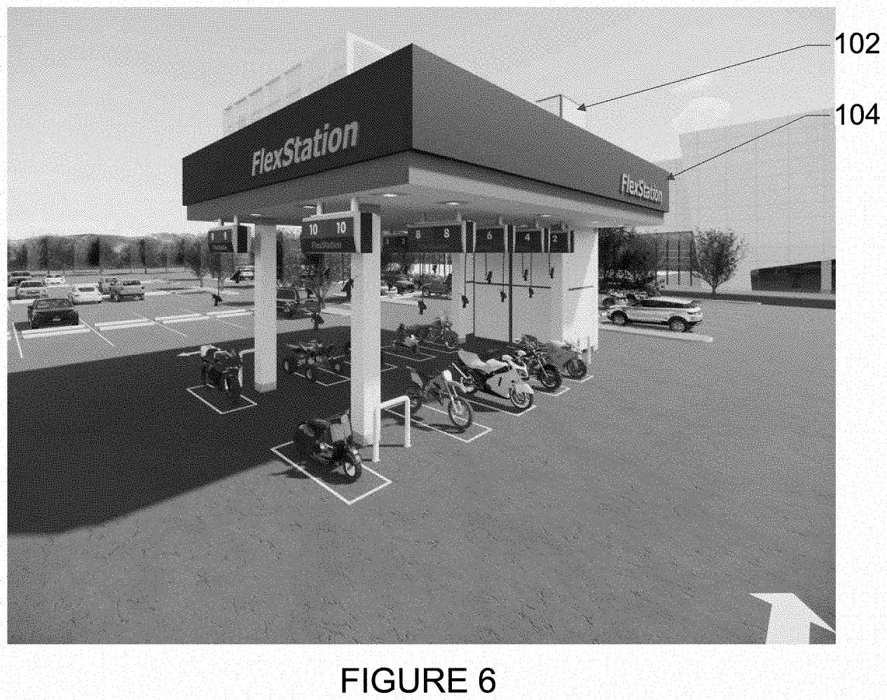

As will be appreciated, dispensers for fuel may be positioned on ground level beneath the canopy 104, or may instead be suspended dispensers 140 and depend therefrom, as shown explicitly in FIG. 6.

The environmentally friendly multifuel fueling platform 100 of the present invention thereby provides an opportunity to significantly reduce the on-site construction timeline for a new fueling station, from many months to as little as, e.g., 6 weeks, while simultaneously ensuring against environmental damage by eliminating the need to excavate and bury fuel tanks.

As shown in FIGS. 1-9D, the preferred structural embodiment of fuel dispensers of the present invention is as split dispensers: that is, the measurement/control equipment of the fuel dispensers (of whatever type) is supported on the top side/canopy of the environmentally friendly multifuel fueling platform. Beneath the canopy, however, the fuel dispensers are essentially just an electronic box and display to control the actual dispensing of the fuel. Therefore, and advantageously, no fuel handling equipment is allocated in the area beneath the canopy. Moreover, and preferably, the split fuel dispensers are installed and supported off the ground on the same structure members/legs as is the environmentally friendly multifuel fueling platform as a whole.

The environmentally friendly multifuel fueling platform of the present invention is structurally designed to resist earthquakes up 9.0 Richter scale, and Cat 5 wind storms, as well as being resistant to vehicle impact on its structural legs.

As therefore disclosed herein, the environmentally friendly multifuel fueling platform of the present invention is modular in nature and can be arranged for different sizes; all fuel modules are compatible (i.e., outer size) to each other no matter what kind of fuel they may be holding, and can therefore share the same foundation. Moreover, the structural platform on top may be surrounded by a facade formed by aluminum panels attached to the structure, where branding image can be displayed.

It will be readily appreciated that many advantages flow from the environmentally friendly multifuel fueling platform of the present invention, such as but not limited to:

The top/upper side of the canopy provides a confined and safe working area. It allows personnel to perform inspection and maintenance of the equipment installed;

The physical footprint of the environmentally friendly multifuel fueling platform of the present invention is much smaller and therefore less cumbersome and expensive than known fuel stations, especially those that require on-ground space and support for, e.g., hydrogen fuels, which the present invention houses in its canopy;

Most of the operative equipment is out of the reach of clients and the general public, as it resides in the canopy, and is therefore also safe and protected from vehicles approaching the environmentally friendly multifuel fueling platform of the present invention;

Providing controlled access to the top side where the equipment is located; and

The present invention allows to change type of fuel and equipment when needed.

Although this invention has been shown and described with respect to the detailed embodiments thereof, it will be understood by those skilled in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. An environmentally friendly multifuel fueling platform, comprising:
a tower structure;
a canopy structure supported on legs a predetermined distance above ground, said canopy structure being releasably affixed to said tower structure;
an energy source, said energy source being housed within said canopy structure; and
wherein said tower structure includes a work platform extending therefrom and over said energy source, thereby providing access thereto.

2. An environmentally friendly multifuel fueling platform, comprising:
a tower structure;
a canopy structure supported on legs a predetermined distance above ground to facilitate the passage of land vehicles thereunder, said canopy structure being releasably affixed to said tower structure;
an energy source, said energy source being housed within said canopy structure; and
wherein said tower provides access to said canopy from said ground, as well as providing operational supply of one of a liquid, gaseous and electrical energies to said energy source.
